(19) United States
(12) Patent Application Publication
(10) Pub. No.: US 2021/0370739 A1
(43) Pub. Date: Dec. 2, 2021

(54) SYSTEM AND METHOD FOR CONTROLLING ACTIVE SUSPENSION OF VEHICLE

(71) Applicants: Hyundai Motor Company, Seoul (KR); Kia Motors Corporation, Seoul (KR)

(72) Inventor: In Seok SEO, Seoul (KR)

(73) Assignees: Hyundai Motor Company, Seoul (KR); Kia Motors Corporation, Seoul (KR)

(21) Appl. No.: 17/088,499

(22) Filed: Nov. 3, 2020

(30) Foreign Application Priority Data
May 27, 2020 (KR) 10-2020-0063808

(51) Int. Cl. B60G 17/0195

(52) U.S. Cl. CPC B60G 17/0195; B60G 2400/10; B60G 2400/0523; B60G 2400/25; B60G 2400/0512

(57) ABSTRACT

A system for controlling an active suspension of a vehicle may include a sensor device mounted on the vehicle to detect a state of the vehicle, and a vehicle controller that estimates a pitch angle of the vehicle using the state information related to the vehicle when pulling of the vehicle occurs in a pitch control situation based on a willingness of a driver to accelerate or decelerate the vehicle, determines a sum of a control force of a front wheel of the vehicle and a control force of a rear wheel of the vehicle for minimizing the pitch angle, and compares a steering intention of the driver with a yaw rate signal of the vehicle to determine control amounts of a left active suspension of the vehicle and a right active suspension of the vehicle based on a magnitude of pulling of the vehicle.

### CROSS-REFERENCE TO RELATED APPLICATION

The present application claims priority to Korean Patent Application No. 10-2020-0063808, filed on May 27, 2020, the entire contents of which is incorporated herein for all purposes by this reference.

### BACKGROUND OF THE INVENTION

### Field of the Invention

The present invention relates to a system and a method for controlling an active suspension of a vehicle having a plurality of wheels, and more particularly to, a system and a method for controlling an active suspension of a vehicle which may improve a straight traveling stability using the active suspension when vehicle pulling occurs in a pitch control situation resulted from driving or braking.

### Description of Related Art

An active suspension system in a vehicle refers to a system that detects various inputs input from a road surface through a sensor, and effectively controls, by an electric control unit (ECU), a roll behavior and the like of the vehicle based on the detected input.

The active suspension system includes an actuator that compensates for a displacement of a coil spring connected to a vehicle wheel. Furthermore, the active suspension system performs a function configured for improving a ride quality and a grip force of the vehicle to the road surface by maintaining a vehicle height constant by properly controlling an amount of fluid supplied to the actuator to detect changes in a roll, a pitch, and the like of the vehicle.

There are various causes of a rolling phenomenon while the vehicle travels. The rolling may damage a travel stability of the vehicle and degrade the ride quality, and the vehicle may overturn because of the severe rolling.

In a case of turning the vehicle, a conventional active suspension system has a problem that the travel stability deteriorates by not properly controlling occurrences of an under steer phenomenon in which a turning radius of a vehicle body becomes greater than an angle of a steering wheel bent during acceleration, and an over steer phenomenon in which the turning radius of the vehicle body becomes smaller than the angle of the steering wheel bent during deceleration.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system and a method for controlling an active suspension of a vehicle which may simultaneously control a pitch and a yaw through the active suspension when vehicle pulling occurs in a pitch control situation resulted from driving or braking, and improve a straight traveling stability without steering assistance through left and right distribution control of the active suspension.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a system for controlling an active suspension of a vehicle includes a sensor device mounted on the vehicle to detect a state of the vehicle, and a vehicle controller that estimates a pitch angle of the vehicle using the state information related to the vehicle when pulling of the vehicle occurs in a pitch control situation based on a willingness of a driver to accelerate or decelerate the vehicle, determines a sum of a control force of a front wheel of the vehicle and a control force of a rear wheel of the vehicle for minimizing the pitch angle, and compares a steering intention of the driver with a yaw rate signal of the vehicle to determine control amounts of a left active suspension of the vehicle and a right active suspension of the vehicle based on a magnitude of the pulling of the vehicle.

In various exemplary embodiments of the present invention, the vehicle controller may be configured to determine that there is the willingness to accelerate when an accelerator signal is ON, and determine that there is the willingness to decelerate when a brake pedal signal is ON.

In various exemplary embodiments of the present invention, the vehicle controller may estimate the pitch angle using a sensor value output through a pitch angle sensor connected to the vehicle controller or a sensor value output through a vehicle height sensor connected to the vehicle controller.

In various exemplary embodiments of the present invention, the vehicle controller may apply a tension force to the front wheel of the vehicle and apply a compression force to the rear wheel to make the pitch angle 0 when the estimated pitch angle is greater than 0, and apply the compression force to the front wheel of the vehicle and apply the tension force to the rear wheel to make the pitch angle 0 when the estimated pitch angle is less than 0.

In various exemplary embodiments of the present invention, the vehicle controller may compare a predetermined reference yaw rate with the yaw rate signal of the vehicle to determine a pulling situation of the vehicle, determine a current situation of the vehicle as a situation where the vehicle is pulled toward a left side when the reference yaw rate is greater than the yaw rate of the vehicle, and determine the current situation of the vehicle as a situation where the vehicle is pulled toward a right side when the reference yaw rate is less than the yaw rate of the vehicle.

In various exemplary embodiments of the present invention, the vehicle controller may increase a tension force at a left front wheel of the vehicle, decrease the tension force at a right front wheel, increase a compression force at a left rear wheel, and decrease the compression force at a right rear wheel when left pulling of the vehicle occurs in a state where the pitch angle of the vehicle is greater than 0, and decrease the tension force at the left front wheel of the vehicle, increase the tension force at the right front wheel, decrease the compression force at the left rear wheel, and increase the compression force at the right rear wheel when right pulling of the vehicle occurs in the state where the pitch angle of the vehicle is greater than 0. The vehicle controller may increase a compression force at a left front wheel of the vehicle, decrease the compression force at a right front wheel, increase a tension force at a left rear wheel, and decrease the tension force at a right rear wheel when left pulling of the vehicle occurs in a state where the pitch angle of the vehicle is less than 0, and decrease the compression force at the left front wheel of the vehicle, increase the compression force at the right front wheel, decrease the tension force at the left rear wheel, and increase the tension force at the right rear wheel when right pulling of the vehicle occurs in the state where the pitch angle of the vehicle is less than 0.

In various exemplary embodiments of the present invention, the vehicle controller may compare slip rates of a left wheel and a right wheel with each other to determine a difference in a coefficient of friction between a left road surface and a right road surface, determine the left road surface as a low friction road surface and determine the right road surface as a high friction road surface when the slip rate of the left wheel is greater than the slip rate of the right wheel, and determine the left road surface as the high friction road surface and determine the right road surface as the low friction road surface when the slip rate of the right wheel is greater than the slip rate of the left wheel.

According to various aspects of the present invention, a method for controlling an active suspension of a vehicle includes a pitch angle estimating operation of determining, by a vehicle controller, a willingness of a driver to accelerate or decelerate the vehicle, and estimating a pitch angle of the vehicle using state information related to the vehicle when pulling of the vehicle occurs in a pitch control situation, a summing operation of determining, by the vehicle controller, a sum of a control force of a front wheel of the vehicle and a control force of a rear wheel of the vehicle for minimizing the pitch angle, and a control amount determining operation of determining a steering intention of the driver, and comparing the steering intention of the driver with a yaw rate signal of the vehicle to determine control amounts of a left active suspension of the vehicle and a right active suspension of the vehicle based on a magnitude of the pulling of the vehicle.

In various exemplary embodiments of the present invention, the pitch angle estimating operation may include determining that there is the willingness to accelerate when an accelerator signal is ON, and determining that there is the willingness to decelerate when a brake pedal signal is ON.

In various exemplary embodiments of the present invention, the pitch angle estimating operation may include estimating the pitch angle using a sensor value output through a pitch angle sensor connected to the vehicle controller or a sensor value output through a vehicle height sensor connected to the vehicle controller.

In various exemplary embodiments of the present invention, the summing operation may include applying a tension force to the front wheel of the vehicle and applying a compression force to the rear wheel to make the pitch angle 0 when the estimated pitch angle is greater than 0, and applying the compression force to the front wheel of the vehicle and applying the tension force to the rear wheel to make the pitch angle 0 when the estimated pitch angle is less than 0.

In various exemplary embodiments of the present invention, the control amount determining operation may include comparing a predetermined reference yaw rate with the yaw rate signal of the vehicle to determine a pulling situation of the vehicle, determining a current situation of the vehicle as a situation where the vehicle is pulled toward a left side when the reference yaw rate is greater than the yaw rate of the vehicle, and determining the current situation of the vehicle as a situation where the vehicle is pulled toward a right side when the reference yaw rate is less than the yaw rate of the vehicle.

In various exemplary embodiments of the present invention, the control amount determining operation may include increasing a tension force at a left front wheel of the vehicle, decreasing the tension force at a right front wheel, increasing a compression force at a left rear wheel, and decreasing the compression force at a right rear wheel when left pulling of the vehicle occurs in a state where the pitch angle of the vehicle is greater than 0, and decreasing the tension force at the left front wheel of the vehicle, increasing the tension force at the right front wheel, decreasing the compression force at the left rear wheel, and increasing the compression force at the right rear wheel when right pulling of the vehicle occurs in the state where the pitch angle of the vehicle is greater than 0. The control amount determining operation may include increasing a compression force at a left front wheel of the vehicle, decreasing the compression force at a right front wheel, increasing a tension force at a left rear wheel, and decreasing the tension force at a right rear wheel when left pulling of the vehicle occurs in a state where the pitch angle of the vehicle is less than 0, and decreasing the compression force at the left front wheel of the vehicle, increasing the compression force at the right front wheel, decreasing the tension force at the left rear wheel, and increasing the tension force at the right rear wheel when right pulling of the vehicle occurs in the state where the pitch angle of the vehicle is less than 0.

In various exemplary embodiments of the present invention, the control amount determining operation may include comparing, by the vehicle controller, slip rates of a left wheel and a right wheel with each other to determine a difference in a coefficient of friction between a left road surface and a right road surface, determining the left road surface as a low friction road surface and determining the right road surface as a high friction road surface when the slip rate of the left wheel is greater than the slip rate of the right wheel, and determining the left road surface as the high friction road surface and determining the right road surface as the low friction road surface when the slip rate of the right wheel is greater than the slip rate of the left wheel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating motion characteristics which may appear during travel of a vehicle;

FIG. 2 is a block diagram illustrating a system for controlling an active suspension of a vehicle according to various exemplary embodiments of the present invention;

FIG. 3, FIG. 4A, FIG. 4B, FIG. 4C, FIG. 4D, and FIG. 4E are views illustrating a process of distributing an active suspension control force based on roll angle control during turning of a vehicle;

FIG. 5A, FIG. 5B, and FIG. 5C are views exemplarily illustrating a change in a lateral force based on a control force distribution during turning of a vehicle;

FIG. 6 and FIG. 7 are views illustrating a relationship of a change in a lateral force based on a change in a vertical load during turning of a vehicle;

FIG. 8 is a flowchart for illustrating a method for controlling an active suspension of a vehicle according to various exemplary embodiments of the present invention;

FIG. 9, FIG. 10 and FIG. 11A, FIG. 11B, FIG. 11C, FIG. 11D, and FIG. 11E are views illustrating an active suspension control force distribution process based on pitch angle control in a braking situation of the vehicle according to various exemplary embodiments of the present invention;

FIG. 12, FIG. 13A, FIG. 13B, and FIG. 13C are views illustrating a vertical force distribution process when controlling a pitch angle of a vehicle according to various exemplary embodiments of the present invention; and

FIG. 14A and FIG. 14B, and FIG. 15 are views illustrating a control process during braking on a road surface asymmetric in a left and right direction according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it may be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, may be interpreted as having a meaning which is consistent with their meaning in the context of the relevant art and will not be interpreted in an idealized or overly formal sense unless so defined herein.

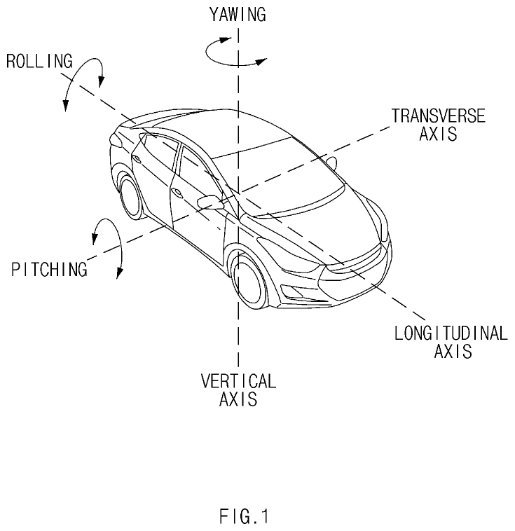

Hereinafter, embodiments of the present invention will be described in detail with reference to FIGS. 1 to 15.

FIG. 1 is a view exemplarily illustrating motion characteristics which may appear during travel of a vehicle. Referring to FIG. 1, while a vehicle travels, motion characteristics such as rolling, yawing, and pitching may appear based on a state of a road surface and a curvature of a road.

The rolling means a movement in a transverse direction with a longitudinal axis of the vehicle as an axis of rotation, the yawing means a movement in a left and right direction with a vertical axis of the vehicle as the axis of rotation, and the pitching means a movement in a front and rear direction with a transverse axis of the vehicle as the axis of rotation.

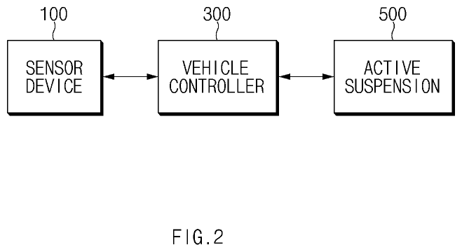

FIG. 2 is a block diagram illustrating a system for controlling an active suspension of a vehicle according to various exemplary embodiments of the present invention.

Referring to FIG. 2, a system for controlling an active suspension of a vehicle according to various exemplary embodiments of the present invention may include a sensor device 100, a vehicle controller 300, and an active suspension 500.

The sensor device 100 may detect state information related to the vehicle including a steering angle, a lateral acceleration, a pitch angle, a vehicle height, an accelerator pedal manipulation amount (an accelerator position), a brake signal, and a driving axis torque of the vehicle, and transmit the detection result to the vehicle controller 300.

To this end, the sensor device 100 may include a steering angle sensor, a lateral acceleration sensor, a pitch angle sensor, a vehicle height sensor, an accelerator pedal sensor (an accelerator position sensor), a brake pressure sensor, a driving axis torque sensor, and the like.

To determine a target roll angle or a target pitch angle required for securing a travel stability of the vehicle, the steering angle and the lateral acceleration of the vehicle may be used to estimate an actual roll angle of the vehicle, and the pitch angle sensor and the vehicle height sensor may be used to estimate an actual pitch angle of the vehicle. Furthermore, the accelerator pedal manipulation amount and the driving axis torque may be used to determine a driver's willingness to accelerate, and the brake signal may be used to determine a driver's willingness to decelerate.

The vehicle controller 300 may receive the state information related to the vehicle detected by the sensor device 100 and control an overall operation of the active suspension 500. The vehicle controller 300 may control the operation of the active suspension 500 such that a roll or a pitch of the vehicle is suppressed in cooperation with another electronic control unit (ECU).

The active suspension 500 may effectively control a roll behavior or a pitch behavior of the vehicle based on an input of the sensor device 100 detected by the vehicle controller 300.

The active suspension system may include an actuator that compensates for a displacement of a coil spring connected to a vehicle wheel. Furthermore, the active suspension system may perform a function configured for improving a ride quality and a grip force of the vehicle to the road surface by maintaining the vehicle height constant by properly controlling an amount of fluid supplied to the actuator to detect changes in the roll, the pitch, and the like of the vehicle.

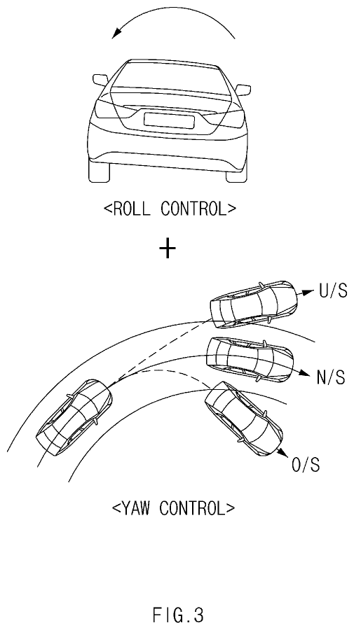

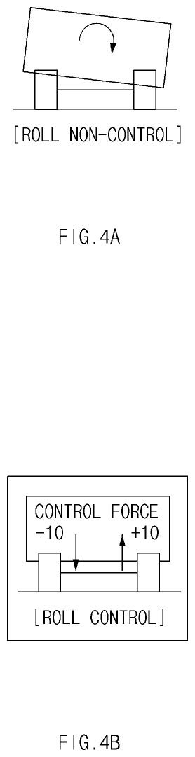

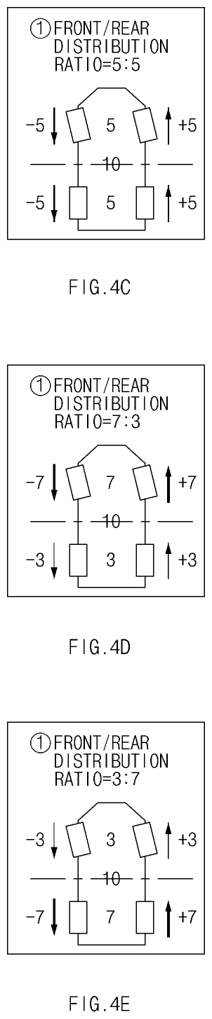

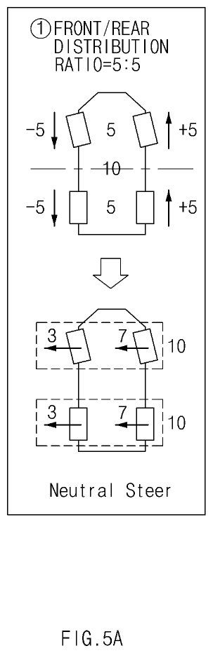

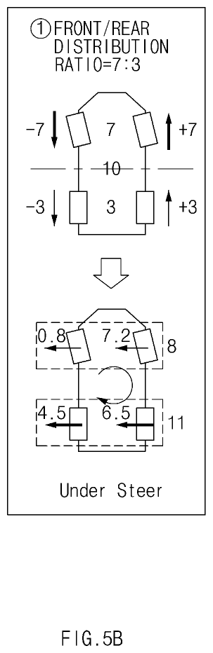

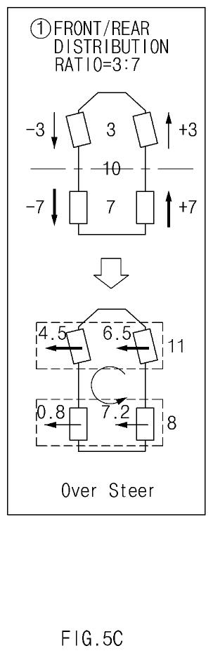

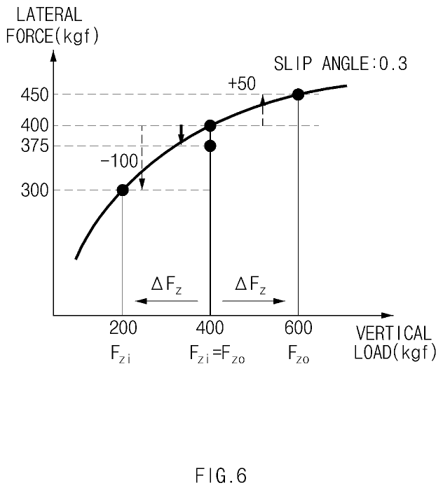

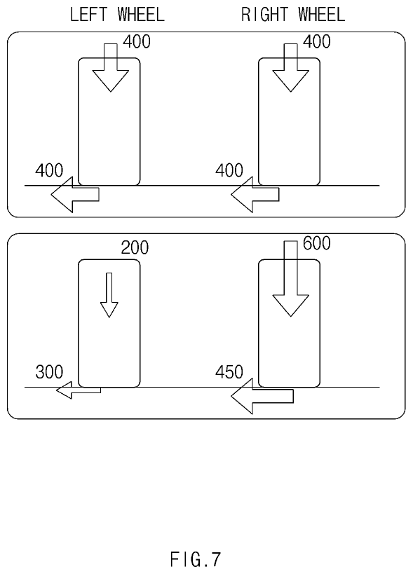

FIG. 3 and FIG. 4A, FIG. 4B, FIG. 4C, FIG. 4D, and FIG. 4E are views illustrating a process of distributing an active suspension control force based on roll angle control during turning of a vehicle. FIG. 5A, FIG. 5B, and FIG. 5C are views exemplarily illustrating a change in a lateral force based on a control force distribution during turning of a vehicle. Furthermore, FIG. 6 and FIG. 7 are views illustrating a relationship of a change in a lateral force based on a change in a vertical load during turning of a vehicle.

Referring to FIG. 3, when controlling a roll angle through the active suspension 500 in a situation where the vehicle is turning, the roll and the yaw may be controlled simultaneously using roll and yaw coupling characteristics. In a situation where the roll angle is kept constant, a yaw behavior may be controlled with U/S (under steer), N/S (neutral steer), and 0/S (over steer) by varying a distribution of front and rear roll moments.

Referring to FIG. 4A, FIG. 4B, FIG. 4C, FIG. 4D, and FIG. 4E, a compression control force and a tension control force of the same magnitude may be applied to a turning internal wheel and a turning external wheel to control the roll angle when the vehicle is turning. In the present connection, regardless of a distribution of the magnitude of the control force allocated to front wheels and rear wheels, a total sum only needs to be constant to generate a desired roll angle (FIG. 4A and FIG. 4B).

For example, assuming that the compression control force and the tension control force required by the left wheels and by the right wheels are 10, respectively, the sums of the control forces are all 10 in a case in which the same control force of 5 was used for all four wheels (FIG. 4C), in a case in which a control force of 7 was used for each of a left front wheel and a right front wheel, and a control force of 3 was used for each of a left rear wheel and a right rear wheel (FIG. 4D), and in a case in which the control force of 3 was used for each of the left front wheel and the right front wheel, and the control force of 7 was used for each of the left rear wheel and the right rear wheel (FIG. 4E), obtaining the same roll angle control result.

However, referring to FIG. 5A, FIG. 5B, and FIG. 5C, in the above three cases (FIG. 4C, FIG. 4D, and FIG. 4E), the yaw behavior may obtain different results based on a control force distribution ratio of the front wheel and the rear wheel.

For example, in a situation in which the control force distribution ratio of the front wheel and the rear wheel is 5:5 (FIG. 5A), because a difference in a change in a tire vertical load resulted from an actuator control force is the same for the front wheel and the rear wheel, lateral forces of the front wheel and the rear wheel are also the same, showing N/S characteristics.

In a situation in which the control force distribution ratio of the front wheel and the rear wheel is 7:3 (FIG. 5B), because the control force of the front wheel is greater than that of the rear wheel, an amount of movement of the vertical load is also greater at the front wheel. Thus, the lateral force of the front wheel becomes smaller than that of the rear wheel, which may show a tendency of the U/S.

In a situation in which the control force distribution ratio of the front wheel and the rear wheel is 3:7 (FIG. 5C), because the control force of the rear wheel is greater than that of the front wheel conversely, the amount of movement of the vertical load is also greater at the rear wheel. Thus, the lateral force of the rear wheel becomes smaller than that of the front wheel, which may show a tendency of the 0/S.

For reference, FIG. 6 shows a dependence of the vertical load on a lateral force of a tire as a relationship of a change in the lateral force based on a change in the vertical load.

In a case of a general tire, when the vertical load increases, the lateral force also increases, and when the vertical load decreases, the lateral force also decreases.

However, a magnitude of the increase or the decrease is not linearly proportional to the change in the magnitude of the vertical load, and shows non-linear characteristics as shown in FIG. 6.

For example, when a vertical load of 400 kgf is applied in a state where a slip angle of an arbitrary tire is 0.3°, a lateral force of such tire may be 400 kgf.

When the vertical load on such tire is increased to 600 kgf, the lateral force may be increased by 50 kgf to become 450 kgf, and when the vertical load is reduced to 200 kgf, the lateral force may be decreased by 100 kgf to become 300 kgf (FIG. 7A and FIG. 7B).

In a comparison of the changes in the lateral force in terms of a resultant force of tires of the left wheel and the right wheel, in a case in which there is no vertical load movement, the lateral force becomes 400+400=800 kgf, and in a case in which there is the vertical load movement, the lateral force becomes 300+450=750 kgf, so that the lateral force may be reduced by 50 kgf compared to the case in which there is no vertical load movement.

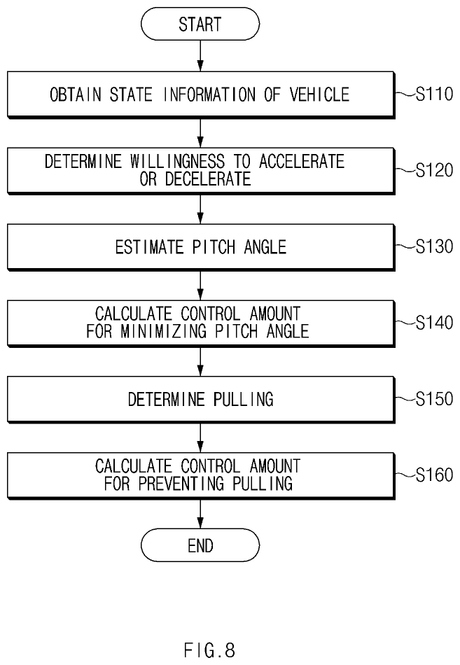

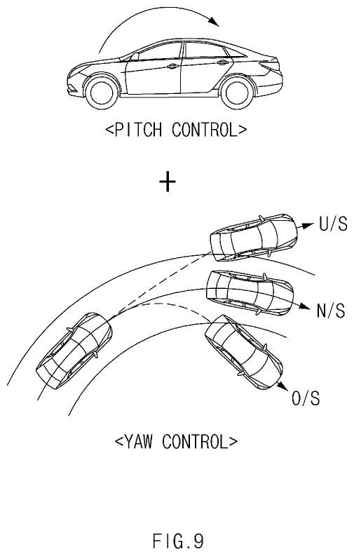

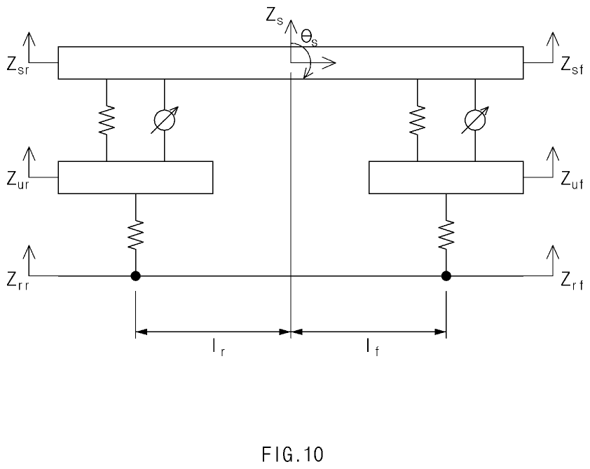

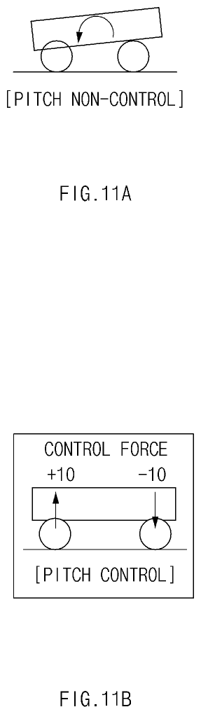

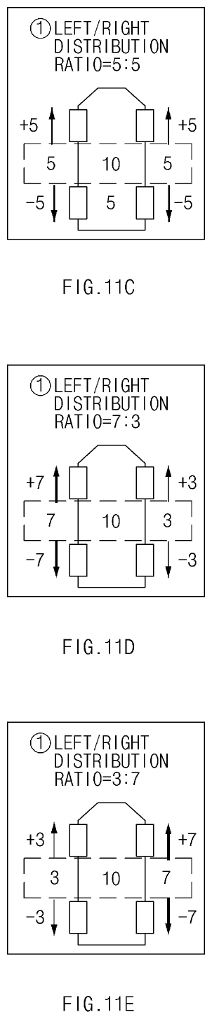

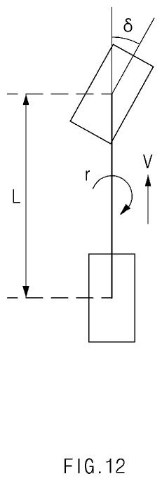

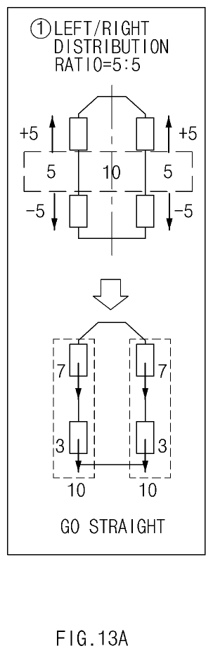

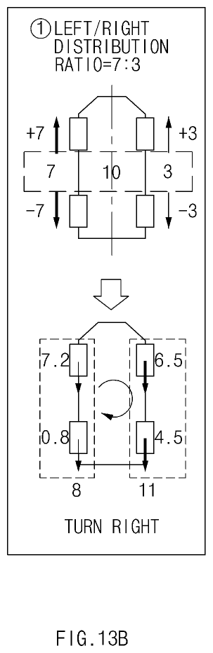

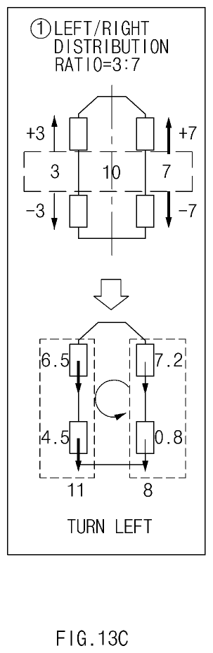

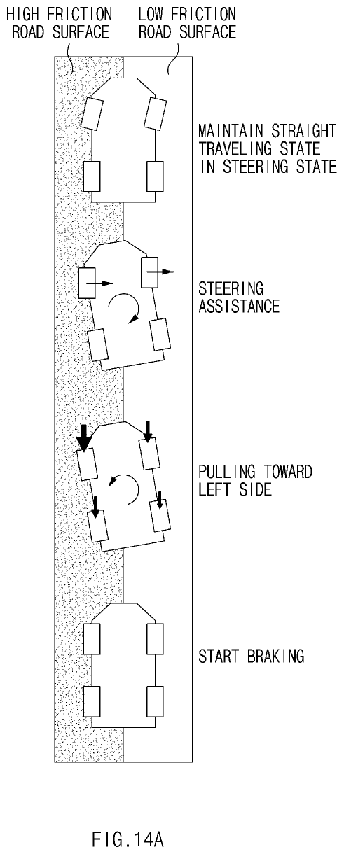

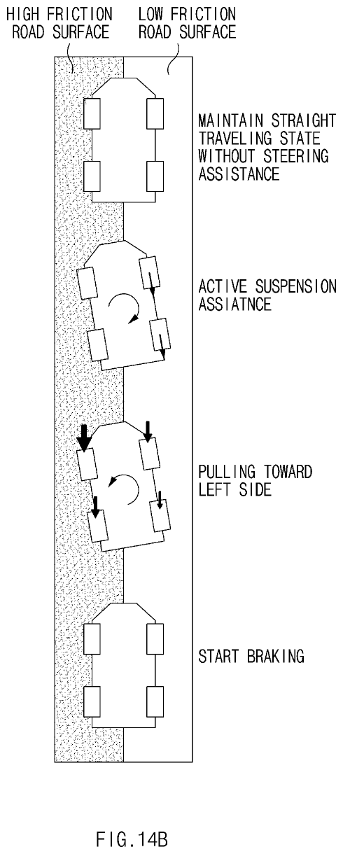

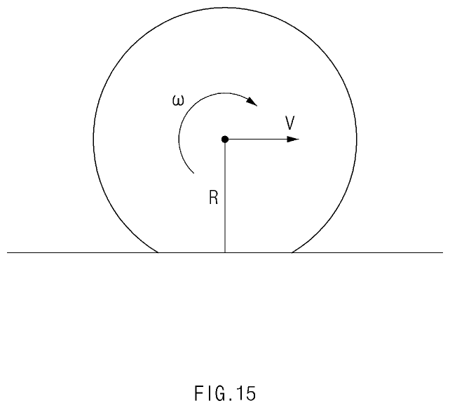

FIG. 8 is a flowchart for illustrating a method for controlling an active suspension of a vehicle according to various exemplary embodiments of the present invention. FIG. 9, FIG. 10 and FIG. 11A, FIG. 11B, FIG. 11C, FIG. 11D, and FIG. 11E are views illustrating an active suspension control force distribution process based on pitch angle control in a braking situation of the vehicle according to various exemplary embodiments of the present invention. FIG. 12, and FIG. 13A, FIG. 13B, and FIG. 13C are views illustrating a vertical force distribution process when controlling a pitch angle of a vehicle according to various exemplary embodiments of the present invention. Furthermore, FIG. 14A and FIG. 14B, and FIG. 15 are views illustrating a control process during braking on a road surface asymmetric in a left and right direction according to various exemplary embodiments of the present invention.

Referring to FIG. 9, when controlling the pitch through the active suspension 500 in a situation in which the vehicle is accelerating or decelerating, the pitch and the yaw may be controlled simultaneously using pitch and yaw coupling characteristics.

When driving or braking on a road surface asymmetric in a left and right direction thereof, because of a difference in a coefficient of friction between a left road surface and a right road surface, a change in the yaw occurs without a steering input, which may be effective in controlling the same.

First, the vehicle controller 300 may obtain the state information related to the vehicle through the sensor device 100 which is mounted on the vehicle and detects a state of the vehicle for controlling the active suspension 500 for improving the travel stability when the vehicle is accelerating or decelerating (S110).

In the present connection, the state of the vehicle may refer to a state in which a pitch situation occurs in the vehicle during vehicle operation.

Accordingly, the vehicle controller 300 may determine the willingness to accelerate or the willingness to decelerate of the driver using the accelerator pedal manipulation amount and the driving axis torque or a brake pedal signal (S120).

For example, when an accelerator pedal signal is ON, it may be determined that there is the willingness to accelerate, and when the brake pedal signal is ON, it may be determined that there is the willingness to decelerate.

Accordingly, when the determination of the willingness to accelerate or decelerate of the driver is completed, the vehicle controller 300 may estimate a current pitch angle of the vehicle using a longitudinal acceleration, a pitch rate, a vehicle height signal, and the like when vehicle pulling occurs in a pitch control situation (S130).

The pitch angle estimation may use a value output from a pitch angle signal as it is when there is the pitch angle sensor.

However, when there is no pitch angle sensor and there is the vehicle height sensor, the pitch angle may be estimated using the vehicle height sensor signal, and the pitch angle may be estimated using a track half-car model according to FIG. 10 and [Mathematical equation 1].

$$θ = {sin}^{- 1} ( \frac{( Z s r - Z u r ) - ( Z s f - Z u f )}{L f + L r} ) \qquad [ Mathematical equation 1 ]$$

Here, θ is the pitch angle, Zs is a center of gravity vertical displacement, Zsf-Zuf is a front wheel vehicle height displacement, Zsr-Zur is a rear wheel vehicle height displacement, Lf is a front wheel wheelbase, and Lr is a rear wheel wheelbase.

Subsequently, a total sum of front wheel control forces and rear wheel control forces for minimizing the pitch angle in a current situation may be determined (S140).

The pitch angle of the vehicle may be controlled by controlling the front wheel control forces and the rear wheel control forces of the vehicle using the active suspension 500.

That is, when the estimated pitch angle is greater than 0, the vehicle is in a dive state, so that the tension force may be applied to the front wheels and the compression force may be applied to the rear wheels to make the pitch angle 0.

Conversely, when the pitch angle is less than 0, the vehicle is in a squat state, so that the compression force may be applied to the front wheels and the tension force may be applied to the rear wheels to make the pitch angle 0.

In the present connection, magnitudes of the left wheel and the right wheel may use the same value.

For example, assuming that the tension control force and the compression control force required by the front wheels and by the rear wheels to minimize the pitch angle during deceleration are 10, respectively (FIG. 11A and FIG. 11B), the same pitch angle control result may be obtained in a case in which the same control force of 5 was used for all the four wheels (FIG. 11C), in a case in which the control force of 7 was used for each of the left front wheel and the left rear wheel, and the control force of 3 was used for each of the right front wheel and the right rear wheel (FIG. 11D), and in a case in which the control force of 3 was used for each of the left front wheel and the left rear wheel, and the control force of 7 was used for each of the right front wheel and the right rear wheel (FIG. 11E).

Subsequently, the vehicle controller 300 may identify an intention of the driver to steer using a steering angle sensor signal, and may compare the identified intention of the driver to steer with a current yaw rate signal of the vehicle to determine whether the vehicle is turning based on the driver's intention or whether the vehicle is turning (pulling) regardless of the driver's intention (S150).

First, the turning state of the vehicle intended by the driver may be defined as a reference yaw rate derived from [Mathematical equation 2] using a steering angle-based bicycle model, with reference to FIG. 12. The reference yaw rate may be compared with an actual yaw rate signal of the vehicle to determine that a current situation is a situation in which the vehicle is pulling in a left direction when the reference yaw rate is greater than the actual yaw rate of the vehicle, and that the current situation of the vehicle is a situation in which the vehicle is pulling in a right direction when the reference yaw rate is less than the actual yaw rate of the vehicle, conversely.

$$Rref = \frac{\frac{V}{L}}{1 + \frac{K {V}^{2}}{L}} δ \qquad [ Mathematical equation 2 ]$$

Here, Rref is the reference yaw rate, V is a vehicle speed, L is a wheelbase length, δ is a steering angle, and K is an under steer gradient.

Subsequently, the vehicle controller 300 may prevent the pulling of the vehicle by determining a control amount distribution ratio of a left active suspension of the vehicle and a right active suspension of the vehicle to secure a straight traveling stability based on a magnitude of the pulling of the vehicle (S160).

TABLE 1

| Vehicle state | | | | | |
|---|---|---|---|---|---|
| Pitch | Pulling | Control force application | | | |
| situation | situation | FL | FR | RL | RR |
| Dive | Left | Tension force | Tension force | Compression | Compression |
| | pulling | increase | decrease | force increase | force decrease |
| | Right | Tension force | Tension force | Compression | Compression |
| | pulling | decrease | increase | force decrease | force increase |
| Squat | Left | Compression | Compression | Tension force | Tension force |
| | pulling | force increase | force decrease | increase | decrease |
| | Right | Compression | Compression | Tension force | Tension force |
| | pulling | force decrease | force increase | decrease | increase |

As shown in [Table 1], a distribution of the control force of the left wheel and the right wheel for preventing the pulling may be determined based on the situation. When left pulling of the vehicle occurs in the dive state where the pitch angle of the vehicle is greater than 0, the tension force may be increased at the left front wheel (FL) of the vehicle, the tension force may be decreased at the right front wheel (FR), the compression force may be increased at the left rear wheel (RL), and the compression force may be decreased at the right rear wheel (RR).

When right pulling of the vehicle occurs in the state where the pitch angle of the vehicle is greater than 0, the tension force may be decreased at the left front wheel (FL) of the vehicle, the tension force may be increased at the right front wheel (FR), the compression force may be decreased at the left rear wheel (RL), and the compression force may be increased at the right rear wheel (RR).

When the left pulling of the vehicle occurs in a squat state where the pitch angle of the vehicle is less than 0, the compression force may be increased at the left front wheel (FL) of the vehicle, the compression force may be decreased at the right front wheel (FR), the tension force may be increased at the left rear wheel (RL), and the tension force may be decreased at the right rear wheel (RR).

When the right pulling of the vehicle occurs in the state where the pitch angle of the vehicle is less than 0, the compression force may be decreased at the left front wheel (FL) of the vehicle, the compression force may be increased at the right front wheel (FR), the tension force may be decreased at the left rear wheel (RL), and the tension force may be increased at the right rear wheel (RR).

In one example, in terms of the yaw of the vehicle, the yaw behavior may obtain different results based on a control force distribution ratio of the left wheel and the right wheel when controlling the pitch angle.

For example, referring to FIG. 13, a situation (FIG. 13A) in which the distribution ratio of the left wheel and right wheel is 5:5 may show straight traveling characteristics as braking forces of the left wheel and the right wheel are the same because differences in the changes in the vertical load resulted from the active suspension control force are the same for the left wheel and the right wheel.

In a situation (FIG. 13B) in which the distribution ratio of the left wheel and the right wheel is 7:3, because the control force of the left wheel is greater than that of the right wheel, the amount of movement of the vertical load is greater at the left wheel. Thus, the braking force of the left wheel becomes smaller than that of the right wheel, so that the vehicle may turn right.

In a situation (FIG. 13C) in which the distribution ratio of the left wheel and the right wheel is 3:7, because the control force of the right wheel is greater than that of the left wheel, conversely, the amount of movement of the vertical load is greater at the right wheel. Thus, the braking force of the right wheel becomes smaller than that of the left wheel, so that the vehicle may turn left.

Furthermore, referring to FIG. 14A and FIG. 14B, the pulling of the vehicle may be prevented by determining the control amount distribution ratio of the left active suspension and the right active suspension of the vehicle to secure the straight traveling stability of the vehicle when braking on the road surface asymmetric in a left and right direction thereof.

When braking on the road surface asymmetric in a left and right direction thereof, in a case of a general vehicle (FIG. 14A), a braking force of a high friction road surface is greater than that of a low friction road surface, so that the vehicle is pulled toward the high friction road surface. When such situation occurs, an experienced driver may reverse a steering to prevent this. Alternatively, a general driver may use a control method of maintaining a straight traveling state by reversing the steering through an automatic steering system.

However, in a case of a vehicle configured for controlling the control amount distribution ratio of the left active suspension and the right active suspension in the same situation (FIG. 14B), the amount of movement of the vertical load may be changed, and accordingly, turning characteristics may also be changed. Thus, the straight traveling state may be maintained with only load movement control without steering assistance.

Furthermore, when an existing steering control method and the control method according to various exemplary embodiments of the present invention are simultaneously applied, because a posture of the vehicle may be stabilized while applying a greater braking force, an effect of further reducing a braking distance may be expected.

For reference, referring to FIG. 15, wheel speed sensor and vehicle speed sensor information may be used to determine a road surface asymmetric in the left and right direction travel situation. Slip rates of the left wheel and the right wheel may be determined and compared with each other to determine the difference in the coefficient of friction of the left road surface and the right road surface.

When the slip rate of the left wheel is greater than that of the right wheel, the left wheel may be determined as the low friction road surface and the right wheel may be determined as the high friction road surface.

Conversely, when the slip rate of the right wheel is greater than that of the left wheel, the left wheel may be determined as the high friction road surface and the right wheel may be determined as the low friction road surface.

The slip rate may be determined using [Mathematical equation 3].

$$slip rate = \frac{vehicle speed ( V ) - Wheel rollingspeed ( R ω )}{vehicle speed ( V )} \times 1 \; 00 ( \% ) \qquad [ Mathematical equation 3 ]$$

According to the According to the system and the method for controlling the active suspension of the vehicle according to various exemplary embodiments of the present invention as described above, when the vehicle pulling occurs in the pitch control situation resulted from the driving or the braking, the pitch and the yaw may be simultaneously controlled through the active suspension, and the straight traveling stability may be improved without the steering assistance through the left and right distribution control of the active suspension.

In one example, the method for controlling the active suspension of the vehicle based on S110 to S160 may be programmed and stored in a recording medium to be read by a computer.

The description above is merely illustrative of the technical idea of the present invention, and various modifications and changes may be made by those skilled in the art without departing from the essential characteristics of the present invention.

Therefore, the exemplary embodiments included in various exemplary embodiments of the present invention are not intended to limit the technical idea of the present invention but to illustrate the present invention, and the scope of the technical idea of the present invention is not limited by the embodiments. The scope of the present invention may be construed as being covered by the scope of the appended claims, and all technical ideas falling within the scope of the claims may be construed as being included in the scope of the present invention.

The present technology has the effects of simultaneously controlling the pitch and the yaw through the active suspension when the vehicle pulling occurs in the pitch control situation resulted from the driving or the braking, and improving the straight traveling stability without the steering assistance through the left and right distribution control of the active suspension.

Furthermore, various effects that are directly or indirectly recognized through the present document may be provided.

Furthermore, the term “controller”, “control unit” or “control device” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller or the control unit may be at least one microprocessor operated by a predetermined program which may include a series of commands for carrying out the aforementioned method in accordance with various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for controlling an active suspension apparatus of a vehicle having a plurality of wheels, the system comprising:
a sensor device mounted on the vehicle to detect a state of the vehicle to provide state information of the vehicle; and
a vehicle controller connected to the sensor device and configured to:
estimate a pitch angle of the vehicle using the state information related to the vehicle upon determining that pulling of the vehicle occurs in a pitch control situation according to a willingness of a driver to accelerate or decelerate the vehicle;
determine a sum of a control force of a front wheel of the vehicle among the plurality of wheels and a control force of a rear wheel of the vehicle among the plurality of wheels for minimizing the pitch angle; and
compare a steering intention of the driver with a yaw rate signal of the vehicle to determine control amounts of a left active suspension apparatus of the vehicle and a right active suspension apparatus of the vehicle according to a magnitude of the pulling of the vehicle.

2. The system of claim 1, wherein the vehicle controller is configured to determine that there is the willingness to accelerate the vehicle upon determining that an accelerator signal is ON, and determine that there is the willingness to decelerate the vehicle upon determining that a brake pedal signal is ON.

3. The system of claim 1,
wherein the sensor device includes a pitch angle sensor and a vehicle height sensor, and
wherein the vehicle controller is configured to estimate the pitch angle using a sensor value output through the pitch angle sensor or a sensor value output through the vehicle height sensor.

4. The system of claim 1, wherein the vehicle controller is configured to:
apply a tension force to the front wheel of the vehicle and apply a compression force to the rear wheel to make the pitch angle 0 upon determining that the estimated pitch angle is greater than 0; and
apply the compression force to the front wheel of the vehicle and apply the tension force to the rear wheel to make the pitch angle 0 upon determining that the estimated pitch angle is less than 0.

5. The system of claim 1, wherein the vehicle controller is configured to:
compare a preset reference yaw rate with the yaw rate signal of the vehicle to determine a pulling situation of the vehicle;
determine a current situation of the vehicle as a situation where the vehicle is pulled toward one side upon determining that the preset reference yaw rate is greater than the yaw rate signal of the vehicle; and
determine the current situation of the vehicle as a situation where the vehicle is pulled toward another side upon determining that the preset reference yaw rate is less than the yaw rate signal of the vehicle.

6. The system of claim 1,
wherein the front wheel includes a left front wheel and a right front wheel,
wherein the rear wheel includes a left rear wheel and a right rear wheel, and
wherein the vehicle controller is configured to:
increase a tension force at the left front wheel of the vehicle, decrease the tension force at the right front wheel, increase a compression force at the left rear wheel, and decrease the compression force at the right rear wheel upon determining that left pulling of the vehicle occurs in a state in which the pitch angle of the vehicle is greater than 0; and
decrease the tension force at the left front wheel of the vehicle, increase the tension force at the right front wheel, decrease the compression force at the left rear wheel, and increase the compression force at the right rear wheel upon determining that right pulling of the vehicle occurs in the state where the pitch angle of the vehicle is greater than 0.

7. The system of claim 1,
wherein the front wheel includes a left front wheel and a right front wheel,
wherein the rear wheel includes a left rear wheel and a right rear wheel, and
wherein the vehicle controller is configured to:
increase a compression force at the left front wheel of the vehicle, decrease the compression force at the right front wheel, increase a tension force at the left rear wheel, and decrease the tension force at the right rear wheel upon determining that left pulling of the vehicle occurs in a state in which the pitch angle of the vehicle is less than 0; and
decrease the compression force at the left front wheel of the vehicle, increase the compression force at the right front wheel, decrease the tension force at the left rear wheel, and increase the tension force at the right rear wheel upon determining that right pulling of the vehicle occurs in the state in which the pitch angle of the vehicle is less than 0.

8. The system of claim 1,
wherein the plurality of wheels includes a left wheel and a right wheel, and
wherein the vehicle controller is configured to:
compare slip rates of the left wheel and the right wheel with each other to determine a difference in a coefficient of friction between a left road surface and a right road surface;
determine the left road surface as a low friction road surface and determine the right road surface as a high friction road surface upon determining that the slip rate of the left wheel is greater than the slip rate of the right wheel; and
determine the left road surface as the high friction road surface and determine the right road surface as the low friction road surface upon determining that the slip rate of the right wheel is greater than the slip rate of the left wheel.

9. A method for controlling an active suspension apparatus of a vehicle having a plurality of wheels, the method comprising:
a pitch angle estimating operation of determining, by a vehicle controller, a willingness of a driver to accelerate or decelerate the vehicle, and estimating a pitch angle of the vehicle using state information related to the vehicle upon determining that pulling of the vehicle occurs in a pitch control situation;
a summing operation of determining, by the vehicle controller, a sum of a control force of a front wheel of the vehicle among the plurality of wheels and a control force of a rear wheel of the vehicle among the plurality of wheels for minimizing the pitch angle; and
a control amount determining operation of determining, by the vehicle controller, a steering intention of the driver, and comparing the steering intention of the driver with a yaw rate signal of the vehicle to determine control amounts of a left active suspension apparatus of the vehicle and a right active suspension apparatus of the vehicle according to a magnitude of the pulling of the vehicle.

10. The method of claim 9, wherein the pitch angle estimating operation includes:
determining that there is the willingness to accelerate the vehicle upon determining that an accelerator signal is ON; and
determining that there is the willingness to decelerate the vehicle upon determining that a brake pedal signal is ON.

11. The method of claim 9, wherein the pitch angle estimating operation includes:
estimating the pitch angle using a sensor value output through a pitch angle sensor connected to the vehicle controller or a sensor value output through a vehicle height sensor connected to the vehicle controller.

12. The method of claim 9, wherein the summing operation includes:
applying a tension force to the front wheel of the vehicle and applying a compression force to the rear wheel to make the pitch angle 0 upon determining that the estimated pitch angle is greater than 0; and
applying the compression force to the front wheel of the vehicle and applying the tension force to the rear wheel to make the pitch angle 0 upon determining that the estimated pitch angle is less than 0.

13. The method of claim 9, wherein the control amount determining operation includes:
comparing a preset reference yaw rate with the yaw rate signal of the vehicle to determine a pulling situation of the vehicle;
determining a current situation of the vehicle as a situation where the vehicle is pulled toward one side upon determining that the preset reference yaw rate is greater than the yaw rate signal of the vehicle; and
determining the current situation of the vehicle as a situation where the vehicle is pulled toward another side upon determining that the preset reference yaw rate is less than the yaw rate signal of the vehicle.

14. The method of claim 9,
wherein the front wheel includes a left front wheel and a right front wheel,
wherein the rear wheel includes a left rear wheel and a right rear wheel, and
wherein the control amount determining operation includes:
increasing a tension force at the left front wheel of the vehicle, decreasing the tension force at the right front wheel, increasing a compression force at the left rear wheel, and decreasing the compression force at the right rear wheel upon determining that left pulling of the vehicle occurs in a state in which the pitch angle of the vehicle is greater than 0; and
decreasing the tension force at the left front wheel of the vehicle, increasing the tension force at the right front wheel, decreasing the compression force at the left rear wheel, and increasing the compression force at the right rear wheel upon determining that right pulling of the vehicle occurs in a state in which the pitch angle of the vehicle is greater than 0.

15. The method of claim 9,
wherein the front wheel includes a left front wheel and a right front wheel,
wherein the rear wheel includes a left rear wheel and a right rear wheel, and
wherein the control amount determining operation includes:
increasing a compression force at the left front wheel of the vehicle, decreasing the compression force at the right front wheel, increasing a tension force at the left rear wheel, and decreasing the tension force at the right rear wheel upon determining that left pulling of the vehicle occurs in a state in which the pitch angle of the vehicle is less than 0; and
decreasing the compression force at the left front wheel of the vehicle, increasing the compression force at the right front wheel, decreasing the tension force at the left rear wheel, and increasing the tension force at the right rear wheel upon determining that right pulling of the vehicle occurs in a state in which the pitch angle of the vehicle is less than 0.

16. The method of claim 9,
wherein the plurality of wheels includes a left wheel and a right wheel, and
wherein the control amount determining operation includes:
comparing, by the vehicle controller, slip rates of the left wheel and the right wheel with each other to determine a difference in a coefficient of friction between a left road surface and a right road surface;
determining the left road surface as a low friction road surface and determining the right road surface as a high friction road surface upon determining that the slip rate of the left wheel is greater than the slip rate of the right wheel; and
determining the left road surface as the high friction road surface and determining the right road surface as the low friction road surface upon determining that the slip rate of the right wheel is greater than the slip rate of the left wheel.

17. A computer-readable recording medium, wherein a program for executing the method of claim 9 is recorded in the computer-readable recording medium.
